(19) United States
(12) Patent Application Publication
(10) Pub. No.: US 2024/0010946 A1
(43) Pub. Date: Jan. 11, 2024

(54) LAUNDRY COMPOSITION

(71) Applicant: Conopco, Inc., d/b/a UNILEVER, Englewood Cliffs, NJ (US)

(72) Inventor: Karl BURGESS, Prenton, Wirral (GB)

(73) Assignee: Conopco, Inc., d/b/a UNILEVER, Englewood Cliffs, NJ (US)

(21) Appl. No.: 18/023,017

(22) PCT Filed: Aug. 30, 2021
(86) PCT No.: PCT/EP2021/073888

§ 371 Date: Feb. 24, 2023

(30) Foreign Application Priority Data
Sep. 9, 2020 (EP) 20195202.5

(51) Int. Cl. C11D 1/83; C11D 11/00; C11D 3/50; C11D 3/00

(52) U.S. Cl. CPC C11D 1/83; C11D 11/0017; C11D 3/505; C11D 3/0068; C11D 1/32

(57) ABSTRACT

An ancillary laundry composition comprising: hydrolysed protein, free perfume and 0 to 2 wt. % anionic and/or cationic surfactant.

### FIELD OF INVENTION

The present invention relates to a method of laundering clothes using ancillary laundry compositions, suitable for providing benefits to fabric during the laundry process.

### BACKGROUND OF THE INVENTION

The consumer preference for ancillary laundry products is growing. Consumers increasingly are looking for laundry products to use in addition to their laundry detergent and fabric conditioner to provide additional benefits to their fabrics. Such products allow the consumer to tailor their laundry process to suit their needs and preferences.

EP 2469679 discloses scent additives. The compositions disclosed therein comprise polyethylene glycol, free perfume and perfume microcapsules and optionally a dye.

WO 2020/035277 discloses a laundry serum composition comprising non-ionic surfactant benefit agents and water.

There remains a need for ancillary laundry compositions which deliver new and improved benefits to fabrics during the laundry process. The methods described herein provide an improved perfume experience for the consumer and/or improve the wicking abilities of a fabric i.e. the ability to absorb moisture from the skins surface and distribute through the fabric.

### SUMMARY OF THE INVENTION

In a first aspect of the present invention is provided a method of laundering clothes, wherein an ancillary laundry composition comprising:
a. Hydrolysed protein
b. Free perfume
c. 0 to 2 wt. % anionic and/or cationic surfactant.
   is added in the wash or rinse stage.

In a second aspect of the present invention is provided a use of a composition as described herein to provide an improved perfume experience for the consumer.

In a third aspect of the present invention is provided a use of a composition as described herein to provide improved moisture wicking capability of fabric treated with the composition.

### DETAILED DESCRIPTION

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

### Ancillary Laundry Compositions

An ancillary laundry composition in the context of the present invention is a laundry composition intended for use in addition to a traditional detergent or fabric conditioner formulation. The ancillary laundry composition provides an additional benefit over and above those delivered by a detergent or fabric conditioner and they provide the consumer with the ability to customise the levels of benefit agents delivered in the wash.

The ancillary laundry composition may be in a solid or liquid form, depending on the selected carrier material.

### Hydrolysed Protein

The compositions as described herein comprise a hydrolysed protein. Compositions of the present invention preferably comprise 0.125 to 10 wt. % hydrolysed protein, preferably, 0.2 to 4 wt. % hydrolysed protein, more preferably 0.25 to 2 wt. % hydrolysed protein.

Protein hydrolysates are proteins which are obtainable by hydrolysis of proteins. Hydrolysis can be achieved by chemical reactions, in particular by alkaline hydrolysis, acid hydrolysis, enzymatic hydrolysis or combinations thereof.

For alkaline or acid hydrolysis, methods such as prolonged boiling in a strong acid or strong base may be employed.

For enzymatic hydrolysis, all hydrolytic enzymes are suitable, for example alkaline proteases. The production of protein hydrolysates are described, for example, by G. Schuster and A. Domsch in soaps and oils Fette Wachse 108, (1982) 177 and Cosm.Toil, respectively. 99, (1984) 63, by H. W. Steisslinger in Parf.Kosm. 72, (1991) 556 and F. Aurich et al. in Tens.Surf.Det. 29, (1992) 389 appeared.

The hydrolysed proteins of the present invention may come from a variety of sources. The proteins may be naturally sourced, e.g from plants or animal sources, or they may be synthetic proteins. Preferably the protein is a naturally sourced protein or a synthetic equivalent of a naturally sourced protein. A preferred class of proteins are plant proteins, i.e. proteins obtained from a plant or synthetic equivalents thereof. Preferably the protein is obtained from a plant. Preferred plant sources include nuts, seeds, beans, and grains.

Particularly preferred plant sources are grains. Examples of grains include cereal grains (e.g. millet, maize, barley, oats, rice and wheat), pseudoceral grains (e.g. buckwheat and quinoa), pulses (e.g. chickpeas, lentils and soybeans) and oilseeds (e.g. mustard, rapeseed, sunflower seed, hemp seed, poppy seed, flax seed). Most preferred are cereal grains, in particular wheat proteins or synthetic equivalents to wheat proteins.

The protein hydrolyzate preferably has a weight-average molecular weight Mw in the range from 300 g/mol to 50,000 g/mol, in particular from 300 g/mol to 15,000 g/mol. The average molecular weight Mw can be determined, for example, by gel permeation chromatography (GPC) (Andrews P., “Estimation of the Molecular Weight of Proteins by Sephadex Gel Filtration”; Biochem J., 1964, 91, pages 222 to 233). The use of protein hydrolysates with average molecular weights in this range leads to a particularly effective perfume benefits.

It is preferred if the protein hydrolyzate is cationically modified. Preferably, a cationically modified wheat protein hydrolysate. Preferably the hydrolysed protein contains at least one radical of the formula:

R1-N⁺(CH₃)₂—CH₂—CH(OH)—CH₂—XR

R1 is an alkyl group having 1 to 30 carbon atoms, an alkenyl group having 1 to 30 carbon atoms, or a hydroxyalkyl group having 1 to 30 carbon atoms. R1 is preferably selected from, a methyl group, a C 10-18 alkyl, or a C 10-13 alkenyl group,

X is O, N or S

R represents the protein residue. The term “protein residue” is to be understood as meaning the backbone of the corresponding protein hydrolyzate formed by the linking of amino acids, to which the cationic group is bound.

The cationization of the protein hydrolysates with the above-described residues can be achieved by reacting the protein hydrolyzates, in particular the reactive groups of the amino acids of the protein hydrolysates, with halides which otherwise correspond to compounds of the above formula (wherein the X—R moiety is replaced by a halogen). Wheat protein hydrolysates are commercially available, for example, from Croda under the trade name ColtideRadiance.

Hydrolyses proteins in the compositions described herein may provide an improved perfume experience for the consumer and/or improve the wicking abilities of a fabric i.e. the ability to absorb moisture from the skins surface and distribute through the fabric.

By improved perfume experience, it is meant an increased intensity on wet and 24 hour dray fabrics.

The moisture wicking capability of the fabric refers to the capability of the fabric, once dried, and in wear, to wick moisture (such as sweat) away from the skin of the wearer. The improved moisture wicking capability of synthetic fabric may be expressed in many ways, including rejuvenating sportswear, improving the lifetime of sportswear, reviving sportswear, caring for sportswear. Alternatively the improved moisture wicking capability of synthetic fabric it may be expressed in terms of the benefits while the garment is being worm, for example: keeping the wearer drier for longer, keeping the wearer cooler for longer, keeping the wearer feeling comfortable for longer. In particular these benefits are seen during exercise when the wearer of the clothes is more likely to sweat.

### Perfume

The compositions of the present invention comprise perfume i.e. free oil perfume or non-confined perfumes. The compositions my preferably also comprise perfume microcapsules.

The compositions of the present invention may comprise one or more perfume compositions. The perfume compositions may be in the form of a mixture of free perfume compositions or a mixture of encapsulated and free oil perfume compositions.

Preferably the compositions of the present invention comprise 0.5 to 20 wt. % perfume ingredients, more preferably 1 to 15 wt. % perfume ingredients, most preferably 2 to 10 wt. % perfume ingredients. By perfume ingredients it is meant the combined free perfume and any encapsulated perfume.

Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N. J. (USA). These substances are well known to the person skilled in the art of perfuming, flavouring, and/or aromatizing consumer products.

Particularly preferred perfume components are blooming perfume components and substantive perfume components. Blooming perfume components are defined by a boiling point less than 250° C. and a LogP greater than 2.5. Substantive perfume components are defined by a boiling point greater than 250° C. and a LogP greater than 2.5. Preferably a perfume composition will Comprise a mixture of blooming and substantive perfume components. The perfume composition may comprise other perfume components.

It is commonplace for a plurality of perfume components to be present in a free oil perfume composition. In the compositions for use in the present invention it is envisaged that there will be three or more, preferably four or more, more preferably five or more, most preferably six or more different perfume components. An upper limit of 300 perfume ingredients may be applied.

Free perfume may preferably be present in an amount from 0.01 to 20 wt. %, more preferably 0.1 to 15 wt. %, more preferably from 0.1 to 10 wt. %, even more preferably from 0.1 to 6.0 wt. %, most preferably from 0.5 to 6.0 wt. %, based on the total weight of the composition.

Preferably some of the perfume components are contained in a microcapsule. Suitable encapsulating materials may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof.

Perfume components contained in a microcapsule may comprise odiferous materials and/or pro-fragrance materials.

Particularly preferred perfume components contained in a microcapsule are blooming perfume components and substantive perfume components. Blooming perfume components are defined by a boiling point less than 250° C. and a LogP greater than 2.5. Substantive perfume components are defined by a boiling point greater than 250° C. and a LogP greater than 2.5. Preferably a perfume composition will comprise a mixture of blooming and substantive perfume components. The perfume composition may comprise other perfume components.

It is commonplace for a plurality of perfume components to be present in a microcapsule. In the compositions for use in the present invention it is envisaged that there will be three or more, preferably four or more, more preferably five or more, most preferably six or more different perfume components in a microcapsule. An upper limit of 300 perfume ingredients may be applied.

Encapsulated perfume may preferably be present in an amount from 0.01 to 20 wt. %, more preferably 0.1 to wt. 15%, more preferably from 0.1 to 10 wt. %, even more preferably from 0.1 to 6.0 wt. %, most preferably from 0.5 to 6.0 wt. %, based on the total weight of the composition.

### Anionic and Cationic Surfactants

The compositions of the present invention are not a traditional laundry detergent or fabric conditioning compositions. The compositions of the present invention preferably comprise low levels or most preferably no anionic or cationic surfactant.

The liquid ancillary composition of the present invention preferably comprises less than 2 wt. % anionic and/or cationic surfactant, more preferably less than 1 wt. % anionic and/or cationic surfactant, even more preferably less than 0.85 wt. % anionic and cationic surfactant and most preferably less than 0.5 wt. % anionic and cationic surfactant. The composition can be completely free of anionic and cationic surfactants.

In other words, the compositions preferably comprise 0 to 2 wt. % anionic and/or cationic surfactant, more preferably, 0 to 1 wt. % anionic and/or cationic surfactant, even more preferably 0 to 0.85 wt. % and most preferably 0 to 0.5 wt. % anionic and/or cationic surfactant. The composition can be completely free of anionic and cationic surfactant.

### Carrier Materials

The carrier material, i.e. the material which constitutes the majority of the ancillary laundry composition may be solid or liquid. The compositions described herein comprises at least 50 wt. % carrier materials, preferably 65 wt. %, more preferably 80 wt. % and most preferably at least 90 wt. % carrier materials, by weight of the composition.

When the ancillary laundry composition is a liquid, the composition may be aqueous or non-aqueous, preferably aqueous. Preferably when the ancillary laundry composition is a liquid the composition comprises at least 50 wt. % water, preferably 65 wt. %, more preferably 80 wt. % water and most preferably at least 90 wt. % water. Other liquid carriers may be solvents such as propylene glycol or low molecular weight polyethylene glycols.

When the ancillary laundry composition is solid the carrier material may be any material which disperses, dissolves, disintegrates or solubilises in water. The composition my comprise one carrier material or a combination of different carrier materials.

The carrier material may be selected from the group consisting of: synthetic polymers (e g, polyethylene glycol, ethylene oxide/propylene oxide block copolymers, polyvinyl alcohol, polyvinyl acetate, and derivatives thereof), proteins (e.g., gelatin, albumin, casein), saccharides (e.g. dextrose, fructose, galactose, glucose, isoglucose, sucrose), polysaccharides (e.g., starch, xanthan gum, cellulose, or derivatives thereof), water-soluble or water dispersible fillers (e.g. sodium chloride, sodium sulfate, sodium carbonate/bicarbonate, zeolite, silica, clay), vegetable soap (e.g. coconut soap beads or palm soap), ethoxylated non-ionic surfactants (having a formula R₁O(R₂O)xH, wherein R₁ preferably comprises 12 to 20 carbon atoms, R₂ is C₂H₄ or mixture of C₂H₄ and C₃H₆ units and x=8 to 120), urea and combinations thereof.

Examples of suitable carrier materials include: water soluble organic alkali metal salt, water soluble inorganic alkaline earth metal salt, water soluble organic alkaline earth metal salt, water soluble carbohydrate, water soluble silicate, water soluble urea, starch, xanthan gum, dextrose, clay, water insoluble silicate, citric acid carboxymethyl cellulose, fatty acid, fatty alcohol, glyceryl diester of hydrogenated tallow, glycerol, polyvinyl alcohol, non-ionic surfactants sold under the trade name Lutensol ex. BASF and combinations thereof.

Preferred carrier materials may be selected from the group consisting of synthetic polymers (e g, polyethylene glycol, ethylene oxide/propylene oxide block copolymers, polyvinyl alcohol, polyvinyl acetate, and derivatives thereof), polysaccharides (e.g., starch, xanthan gum, cellulose, or derivatives thereof), saccharides (e.g, dextrose, fructose, galactose, glucose, isoglucose, sucrose), vegetable soap (e.g. coconut soap beads or palm soap), ethoxylated non-ionic surfactants (having a formula R₁O(R₂O)xH, wherein R₁ preferably comprises 12 to 20 carbon atoms, R₂ is C₂H₄ or mixture of C₂H₄ and C₃H₆ units and x=8 to 120) and combinations thereof.

More preferably the carrier is selected from polyethylene glycol, starch, dextrose, coconut soap beads, palm soap and combinations thereof.

Polyethylene glycol comes in various weight average molecular weights. A suitable weight average molecular weight of PEG for the purposes of the present invention includes from 4,000 to 12,000, preferably 5,000 to 11,000, more preferably 6,000 to 10,000 and most preferably 7,000 to 9,000. Non-limiting examples of suitable PEG is are: Polyglycol 8000 ex Clariant and Pluriol 8000 ex BASF.

Saccharides are molecular compounds comprising carbon, hydrogen and oxygen. For the purposes of this invention a saccharide is defined as comprising one to ten monosaccharide units and mixtures thereof. In other words either a monosaccharide or an oligosaccharide or mixtures thereof. An oligosaccharide is a short saccharide polymer, typically considered in the art to comprise between two and ten monosaccharides units. It is preferred that a saccharide comprises 1 to 5 monosaccharide units, more preferably 1 to 4 monosaccharide units, most preferably the saccharide comprises monosaccharides, disaccharides or mixtures thereof. Disaccharides are the product of a reaction between two monosaccharides. They may be formed from two identical monosaccharides or two different monosaccharides. Examples of disaccharides include: sucrose, maltose, lactose. Monosaccharides are simple sugar units having the general formula (CH₂O)ₙ.

Commonly n is 3, 5 or 6. According, monosaccharides can be classified by the number n, for example: trioses (e.g. glyceraldehyde), pentoses (e.g. ribose) and hexoses (e.g. fructose, glucose and galactose). Some monosaccharides may be substituted with additional functional groups, e.g. Glucosamine, others may have undergone deoxgenation and lost an oxygen atom e.g. deoxyribose. Therefore, the general chemical formulae can vary slightly depending on the monosaccharide.

Preferred monosaccharides for the present invention are hexose molecules (n=6). Hexose molecules all have the same molecular formula, however, have a different structural formula, i.e. are structural isomers. It is preferred that the hexose comprises a 6-membered ring, opposed to a 5 membered ring. Glucose and galactose have 6-membered rings. In a preferred embodiment the hexose monosaccharide is glucose. Glucose is a chiral molecule, having a mixture of D and L stereo isomers. Particularly preferably, the glucose of the present invention is the D isomer of glucose, also known as dextrose.

Preferably a saccharide material used in the present invention is anhydrous, i.e. free of any water. For example, dextrose monohydrate contains one molecule of water whereas anhydrous dextrose contains none.

Non-limiting examples of suitable saccharides for the present invention are: C*Dex ex Cargill, Treha ex Cargill, Anhydrous Dextrose ex Foodchem.

When a saccharide is used in the present invention, it may be preferable to include bitter material such as Bitrex ex Johnson Matthey Fine Chemicals, due to the sweetness of the saccharide.

Preferred ethoxylated non-ionic surfactants have a general formula RO(C₂H₄O)xH, wherein R is a saturated alcohol having a carbon chain of C12 to C20 and wherein x is 8 to 120, preferably 25 to 90 and most preferably 45 to 85.

### Non-Ionic Surfactants

The ancillary laundry composition may preferably comprise non-ionic surfactant. Non-ionic surfactants are particularly preferable when the composition is a liquid composition, especially an aqueous liquid composition. If the ancillary laundry composition is a solid, having ethoxylated non-ionic surfactants as carrier materials, an additional non-ionic surfactant may also be present. Preferably the composition comprises 0.5 to 15 wt. % non-ionic surfactant, more preferably 0.5 to 10 wt. % non-ionic surfactant, most preferably 0.5 to 6 wt. % non-ionic surfactant. The correct amount of non-ionic surfactant is important to achieve the desired delivery of the perfume. The compositions may require sufficient non-ionic surfactant to carry the benefit agent, however too much non-ionic surfactant will interfere with the action of the laundry liquid or powder with which it is used and will prevent release of the perfume due to insufficient dilution.

The non-ionic surfactants will preferably have an HLB value of 12 to 20, more preferably 14 to 18.

Examples of non-ionic surfactant materials include: ethoxylated materials, polyols such as polyhydric alcohols and polyol esters, alkyl polyglucosides, EO-PO block copolymers (Poloxamers). Preferably, the non-ionic surfactant is selected from ethoxylated materials.

Preferred ethoxylated materials include: fatty acid ethoxylates, fatty amine ethoxylates, fatty alcohol ethoxylates, nonylphenol ethoxylates, alkyl phenol ethoxylate, amide ethoxylates, Sorbitan(ol) ester ethoxylates, glyceride ethoxylates (castor oil or hydrogenated castor oil ethoxylates) and mixtures thereof.

More preferably, the non-ionic surfactant is selected from ethoxylated surfactants having a general formula:

R¹O(R²O)ₓH

R¹=hydrophobic moiety.
R²=C₂H₄ or mixture of C₂H₄ and C₃H₆ units
x=4 to 120
R¹ preferably comprises 8 to 25 carbon atoms and mixtures thereof, more preferably 10 to 20 carbon atoms and mixtures thereof most preferably 12 to 18 carbon atoms and mixtures thereof. Preferably, R is selected from the group consisting of primary, secondary and branched chain saturated and/or unsaturated hydrocarbon groups comprising an alcohol, carboxy or phenolic group. Preferably R is a natural or synthetic alcohol.
R² preferably comprises at least 50% C₂H₄, more preferably 75% C₂H₄, most preferably R² is C₂H₄.
x is preferably 8 to 90 and most preferably 10 to 60.

Examples of commercially available, suitable non-ionic surfactants include: Genapol C200 ex. Clariant and Eumulgin CO40 ex. BASF.

### Rheology Modifier

If the composition is in a liquid form the composition preferably comprises a rheology modifier. Rheology modifiers are particularly preferred in compositions comprising microcapsules. Rheology modifiers may be inorganic or organic, polymeric or non polymeric. Non-limiting examples of suitable rheology modifiers include: pectine, alginate, arabinogalactan, carageenan, gellan gum, polysaccharides such as xanthum gum, guar gum, acrylates/acrylic polymers, water-swellable clays, fumed silicas, acrylate/aminoacrylate copolymers, salts and mixtures thereof.

Preferred rheology modifier for compositions comprising microcapsules herein include those selected from the group consisting of acrylate/acrylic polymers, gellan gum, fumed silicas, acrylate/aminoacrylate copolymers, water-swellable clays, polysaccharides such as xanthum gum and mixtures thereof. Most preferably the rheology modifier is selected from polysaccharides such as xanthum gum, acrylate/acrylic polymers, acrylate/aminoacrylate copolymers, and water-swellable clays. Most preferred rheology modifier are polysaccharides such as xanthum gum.

When present, a rheology modifier is preferably present in an amount of 0.001 to 10 wt. % percent, preferably from 0.005 to 5 wt. %, more preferably 0.01 to 3 wt. % of the composition.

### Preservatives

The composition of the present invention preferably comprises preservatives. Preservatives are preferably present in an amount of 0.001 to 1 wt. % of the composition. More Preferably 0.005 to 0.5 wt. %, most preferably 0.01 to 0.1 wt. % of the composition.

Preservatives can include anti-microbial agents such as isothiazolinone-based chemicals (in particular isothiazol-3-one biocides) or glutaraldehyde-based products. Also suitable are preservatives such as organic acids, sorbates and benzoates. Examples of suitable preservatives include Benzisothiazoline, Cloro-methyl-isothiazol-3-one, Methyl-isothiazol-3-one and mixtures thereof. Suitable preservatives are commercially available as Kathon CG ex. Dow and Proxel ex Lonza.

### Colourant

The compositions of the present invention preferably comprise a colourant. The colourant may be a dye or a pigment or a mixture thereof. The colourant has the purpose to impart colour to the composition, it is not intended to be a shading dye or to impart colour to the laundered fabrics. A single colourant or a mixture of colourants may be used.

Preferably, the colourant is a dye, more preferably a polymeric dye. Non-limiting examples of suitable dyes include the LIQUITINET range of dyes ex Milliken Chemical.

Preferably the composition of the present invention comprise 0.001 to 2 wt. %, more preferably 0.005 to 1 wt. %, most preferably 0.01 to 0.6 wt. %.

### Optional Ingredients

The compositions of the present invention may contain further optional laundry ingredients. Such ingredients include pH buffering agents, perfume carriers, hydrotropes, polyelectrolytes, anti-shrinking agents, anti-oxidants, anti-corrosion agents, drape imparting agents, anti-static agents, ironing aids, antifoams, colorants, pearlisers and/or opacifiers, natural oils/extracts, processing aids, e.g. electrolytes, hygiene agents, e.g. anti-bacterials and antifungals, thickeners, low levels of cationic surfactants such as quaternary ammonium compounds and skin benefit agents.

### Form of Composition

When the composition is a liquid, the viscosity of the laundry composition is preferably 50 to 15000 mPa·s, more preferably 100 to 1000 mPa·s, most preferably 100 to 800 mPa·s. This viscosity provides the benefit that a laundry liquid can carry the ancillary composition into the laundry process. The viscosity measurement can be carried out at 25° C., using a 4 cm diameter 2° cone and plate geometry on a DHR-2 rheometer ex. TA instruments. In detail, the measurement can be conducted using a TA-Instruments DHR-2 rheometer with a 4 cm diameter 2 degree angle cone and plate measuring system. The lower Peltier plate is used to control the temperature of the measurement to 25° C. The measurement protocol is a ‘flow curve’ where the applied shear stress is varied logarithmically from 0.01 Pa to 400 Pa with 10 measurement points per decade of stress. At each stress the shear strain rate is measured over the last 5 seconds of the 10 second period over which the stress is applied with the viscosity at that stress being calculated as the quotient of the shear stress and shear rate.

The liquid composition as described herein may be manufactured simple by adding the ingredients to the liquid carrier (i.e. water) with stirring.

When the composition is a solid it may be in any solid form, for example: powder, pellet, tablet, prill, pastille or extrudate. Preferably the composition in the form of a pastille or extrudate. Pastilles can, for example, be produced using ROTOFORMER Granulation Systems ex. Sandvick Materials.

The solid compositions of the present invention may be formed from a melt. The solid composition can for example, be formed into particles by: Pastillation e.g. using a ROTOFORMER ex Sandvick Materials, extrusion, prilling, by using moulds, casting the melt and cutting to size or spraying the melt.

An example manufacturing process may involve melting the carrier material at a temperature above the melting point of the carrier material, preferably at least 2° C. above the melting point of the carrier material, more preferably at least 5° C. above the melting point of the carrier material. Where more than one carrier materials are used, the melting point is considered to the highest of the melting points of the individual materials. Once melted, the hydrolysed protein, perfume and other ingredients may be mixed into the compositions. This is followed by a process in which the melt in cooled and shaped, eg. extrusion or pastillation.

The solid compositions of the present invention are preferably homogeneously structured. By homogeneous, it is meant that there is a continuous phase throughout the solid product. There is not a core and shell type structure. Any particles present such as perfume microcapsules will be distributed within the continuous phase. The continuous phase is provided predominately by the carrier materials.

The solid compositions may be any shape or size suitable for dissolution in the laundry process. Preferably, each individual particle of the solid composition has a mass of between 0.95 mg to 5 grams, more preferably 0.01 to 1 gram and most preferably 0.02 to 0.5 grams. Preferably each individual particle has a maximum linear dimension in any direction of 10 mm, more preferably 1-8 mm and most preferably a maximum linear dimension of 4-6 mm. The shape of the particles may be selected for example from spherical, hemispherical, compressed hemispherical, lentil shaped, oblong, or planar shapes such as petals. A preferred shape for the particles is hemispherical, i.e. a dome shaped wherein the height of the dome is less than the radius of the base. When the particles are compressed hemispherical, it is preferred that diameter of the substantially flat base provides the maximum linear dimension and the height of the particle is 1-5 mm, more preferably 2-3 mm. the dimensions of the particles of the present invention can be measured using Calipers.

### In Use

The ancillary laundry compositions are added to the laundry process in either the wash or the rinse phase of the laundry process. Preferably the ancillary laundry composition is added during the rinse phase of the laundry process.

The compositions comprise less than 2 wt. % cationic and/or anionic surfactant (i.e. 0 to 2 wt. %). Therefore, the ancillary composition alone does not deliver any detersive action, nor does it deliver fabric softening cationic surfactants. The compositions are intended for use in combination with traditional laundry liquids (detergent or fabric conditioner) or powder.

In one aspect of the present invention is provided a method of laundering clothes, wherein a composition as described herein is added in the wash or rinse stage, preferably the rinse stage.

In one aspect of the present invention there is provided the use of the compositions described herein to provide an improved (increased) perfume experience to the consumer, in particular on wet and 24 hour dry fabrics. Increased perfume experience means that the consumer can smell more fragrance, or there is an increased fragrance odour. In particular the laundered fabric may have an increased fragrance odour.

In another aspect of the present invention there is provided the use of the compositions described herein to provide improved moisture wicking capability of fabric, preferably synthetic fabric, most preferably polyester. The moisture wicking capability of the fabric refers to the capability of the fabric, once dried, and in wear, to wick moisture (such as sweat) away from the skin of the wearer. The improved moisture wicking capability of synthetic fabric may be expressed in many ways, including rejuvenating sportswear, improving the lifetime of sportswear, reviving sportswear, caring for sportswear. Alternatively the improved moisture wicking capability of synthetic fabric it may be expressed in terms of the benefits while the garment is being worm, for example: keeping the wearer drier for longer, keeping the wearer cooler for longer, keeping the wearer feeling comfortable for longer. In particular these benefits are seen during exercise when the wearer of the clothes is more likely to sweat.

The use of a composition as described herein may provide a multi-wash benefit, in particular a 5 wash benefit. By 5 wash benefit it is meant that the improved moisture wicking benefit is particularly evident after 5 washes. ‘washes’ is a colloquial term for the laundry process; in this context ‘wash’ refers to the process of laundering clothes and includes the wash, rinse and drying stages of the laundry process. In particular sports clothes washed 5 times with a composition as described herein may demonstrate a significant moisture wicking benefit.

The use to provide improved moisture wicking capability of fabric is preferably for synthetic fibres. Synthetic fibres are fibres made by chemical synthesis, as opposed to natural fibres that are directly derived from living organisms. Examples of synthetic fibres are polyester, nylon, polyvinyl chloride (PVC), spandex/lycra/elastane and acrylic fibres. The fabric comprising synthetic fibres preferably comprises 20 wt. % to 100 wt. % synthetic fibres, more preferably 40 wt. % to 100 wt. % synthetic fibres, more preferably 60 wt. % to 100 wt. % synthetic fibres and most preferably 80 wt. % to 100 wt. % synthetic fibres by weight of the fabric. Preferably the use to provide improved moisture wicking capability of fabric is for treating fabric comprising 20 wt. % to 100 wt. % polyester, more preferably 40 wt. % to 100 wt. % polyester, more preferably 60 wt. % to 100 wt. % polyester and most preferably 80 wt. % to 100 wt. % polyester by weight of the fabric. Preferably the use to provide improved moisture wicking capability of fabric is for treating fabric comprising only synthetic fibres (i.e. 100% synthetic fibres), most preferably the fabric comprises 100% polyester.

### EXAMPLE COMPOSITIONS

TABLE 1
Liquid compositions

Inclusion % by weight

| Ingredient | 1 | 2 |
|---|---|---|
| Hydrolysed protein ¹ | 2 | 1 |
| Non-ionic surfactant ² | 4 | 6 |
| Free perfume | 10 | 8 |
| Encapsulated perfume | — | 2 |
| Rheology modifier ³ | — | 0.2 |
| Water | To 100 | To 100 |

Hydrolysed protein ¹ - Coltide radiance ex. Croda
Non-ionic surfactant ² - Eumulgin CO40 ex. BASF
Rheology modifier ³ - xanthan gum

TABLE 2
Solid compositions

Inclusion % by weight

| Ingredient | 3 | 4 |
|---|---|---|
| PEG 8000 ⁴ | 70 | 91.09 |
| Starch ⁵ | 20 | — |
| Hydrolysed protein ¹ | 3 | 1 |
| Blue dye ⁶ | — | 0.01 |
| Free perfume | 7 | 5 |
| Perfume microcapsules | — | 2 |

PEG 8000 ⁴ - Polyglycol 8000 ex Clariant
Starch ⁵ - Tapioca C*Creamgel 7001 ex Cargill
Blue dye ⁶ - Milliken Liquitint Blue HP

1-11. (canceled)

12. A method of laundering clothes, wherein an ancillary laundry composition comprising:
a. hydrolysed protein;
b. free perfume; and
c. 0 to 0.85 wt % anionic surfactant, cationic surfactant or both
is added to a wash or rinse stage of a laundering process, wherein the composition is a liquid.

13. The method according to claim 12, wherein the hydrolysed protein is a plant protein.

14. The method according to claim 12, wherein the protein is a wheat protein.

15. The method according to claim 12, wherein the composition comprises 0.01 to 20 wt. % free perfume.

16. The method according to claim 12, wherein the composition comprises perfume microcapsules.

17. The method according to claim 12, wherein the composition comprises at least 50 wt. % water.

18. The method according to claim 12, wherein the method improves the perfume odour of the clothes after the laundering process.

19. The method according to claim 12, wherein the method improves the moisture wicking capability the cloths after the laundering process.
